(19) United States
(12) Patent Application Publication
(10) Pub. No.: US 2021/0287070 A1
(43) Pub. Date: Sep. 16, 2021

(54) DATA PROCESSING APPARATUS, DATA PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Tsewei Chen, Tokyo (JP); Masami Kato, Kanagawa (JP)

(21) Appl. No.: 17/191,777

(22) Filed: Mar. 4, 2021

(30) Foreign Application Priority Data
Mar. 11, 2020 (JP) 2020-042183

(51) Int. Cl. G06N 3/04

(52) U.S. Cl. CPC G06N 3/0454

(57) ABSTRACT

A data processing apparatus comprises a holding unit configured to hold filter coefficients of a transferred filter, a generating unit configured to generate an extended filter by extending a size of the transferred filter while sequentially reading out the filter coefficients held in the holding unit, and an arithmetic unit configured to perform convolution by using filter coefficients of the extended filter.

### BACKGROUND OF THE INVENTION

### Field of the Invention

The present invention relates to a filtering process technique.

### Description of the Related Art

Recently, the progress of deep learning is increasing the accuracy of image recognition. A CNN (Convolutional Neural Network) is known as a method to be used in deep learning.

In the CNN, a plurality of layers are hierarchically connected, and each layer contains a plurality of feature images. FIG. 2 shows an example of the network configuration of the CNN in which the number of layers is 4 and each layer contains four feature images. The CNN calculates the result of a filtering process by using a learned filter coefficient (weighting factor) for pixels (feature data) of the feature image. The filtering process is a product-sum operation and includes a plurality of multiplications and a plurality of cumulative additions. Each arrow in FIG. 2 represents the product-sum operation.

A feature image in a current layer is calculated by using a feature image in a preceding layer and a filter coefficient corresponding to the preceding layer. Calculating one feature image in the current layer requires information of a plurality of feature images in the preceding layer. A product-sum operation for obtaining a feature image in the current layer is performed in accordance with equation (1) below:

O_{i,j}(n)=Σₘ₌₁^{M}Σₓ₌₀^{X-1}Σ_{y=0}^{Y-1}(l_{i+x,j+y}(m)×C_{x,y}(m,n)) (1)

where n is the index of a feature image in the current layer, and m (m=1 to M) is the index of a feature image in the preceding layer. O_{i,j}(n) indicates feature data (a product-sum operation result) in a position (i, j) in a feature image having index=n in the current layer I_{i,j}(m) indicates feature data in a position (i, j) in a feature image having index=m in the preceding layer. C_{x,y}(m, n) indicates a filter coefficient between the feature image having index=n in the current layer and the feature data in the position (x, y) in the feature image having index=m in the preceding layer. In equation (1), the number of filter coefficients (C_{0,0}(m, n) to C_{X-1,Y-1}(m, n)) is (X×Y), and they change in accordance with feature images. X and Y are variables indicating a reference range. The number of product-sum operations for calculating feature data of the current layer is (M×X×Y).

After the filtering process, processes such as an activation process and pooling are performed based on the network structure by using the product-sum operation result O_{i,j}(n), thereby calculating feature images of the current layer.

The CNN is also applied to image segmentation. Dilated convolution described in Y. Wei, et al., “Revisiting Dilated Convolution. A Simple Approach for Weakly- and Semi-Supervised Semantic Segmentation,” IEEE/CVF Conference on Computer Vision and Pattern Recognition, 2018 is a technique for improving the accuracy of image segmentation. When performing the dilated convolution, a product-sum operation is performed in accordance with equation (2) below:

O_{i,j}(n)=Σₘ₌₁^{M}Σₓ₌₀^{X-1}Σ_{y=0}^{Y-1}(l_{i+Dx,j+Dy}(m)×C_{x,y}(m,n)) (1)

where a variable D is the dilation rate of the dilated convolution. When the variable D is 1, equation (2) is the same as equation (1). The larger the value of the variable D, the wider the reference range in a feature image of a preceding layer. After dilation, the reference range changes from (X×Y) to [D×(X−1)+1]×[D×(Y−1)+1]. In this operation, the processing is performed without skipping filter coefficients. To process feature data of a feature image at intervals of (D−1) data, however, feature data in the horizontal direction or the vertical direction are referred to as they are skipped.

In the CNN, the number of times of product-sum operations is large. When applying the CNN to a portable terminal or an embedded system such as an in-vehicle device, therefore, it is necessary to reduce the transfer amounts of feature data and filter coefficients, efficiently perform product-sum operations, and shorten the overall processing time. Japanese Patent Laid-Open No. 2018-67154 has proposed an arrangement that processes a plurality of feature data in parallel.

This method described in Japanese Patent Laid-Open No. 2018-67154 calculates output data in parallel by using a plurality of different feature data and a common filter coefficient. However, when performing processing such as the dilated convolution described in Y. Wei, et al., “Revisiting Dilated Convolution: A Simple Approach for Weakly- and Semi-Supervised Semantic Segmentation,” IEEE/CVF Conference on Computer Vision and Pattern Recognition, 2018, it is impossible to refer to feature data of feature images in a preceding layer while skipping the data. A register for holding feature data must be connected to a register for holding feature data in the skip destination, control and wiring become complicated. In addition, when dilating a filter by increasing the filter size in order to perform the dilated convolution, the filter coefficient transfer amount increases.

### SUMMARY OF THE INVENTION

The present invention provides a technique for reducing the transfer amount of filter coefficients for use in a filtering process in a case in which the filtering process is performed by extending the range of data to be referred to.

According to the first aspect of the present invention, there is provided a data processing apparatus comprising: a holding unit configured to hold filter coefficients of a transferred filter; a generating unit configured to generate an extended filter by extending a size of the transferred filter while sequentially reading out the filter coefficients held in the holding unit; and an arithmetic unit configured to perform convolution by using filter coefficients of the extended filter.

According to the second aspect of the present invention, there is provided a data processing method to be performed by a data processing apparatus, comprising: holding filter coefficients of a transferred filter, generating an extended filter by extending a size of the transferred filter while sequentially reading out the held filter coefficients; and performing convolution by using filter coefficients of the extended filter.

According to the third aspect of the present invention, there is provided a non-transitory computer-readable storage medium storing a computer program for causing a computer to function as: a generating unit configured to generate an extended filter by extending a size of a transferred filter while sequentially reading out filter coefficients of the transferred filter; and an arithmetic unit configured to perform convolution by using filter coefficients of the extended filter.

Further features of the present invention will become apparent from the following description of exemplary embodiments (with reference to the attached drawings).

### BRIEF DESCRIPTION OF THE DRAWINGS

FIG. 1 is a flowchart of a filtering process to be performed by a data processing apparatus;

FIG. 2 is a view showing a configuration example of a hierarchical neural network (CNN);

FIG. 3 is a block diagram showing a hardware configuration example of the data processing apparatus;

FIG. 4 is a block diagram showing a configuration example of a processing unit 305:

FIG. 5 is a view showing examples of effective coefficients and processing times in a dilated filter;

FIG. 6 is a view showing examples of filters before and after dilation;

FIG. 7 is a block diagram showing a configuration example of the processing unit 305;

FIG. 8 is a view showing an example of convolution in the hierarchical neural network;

FIG. 9 is a flowchart showing details of processing in step S108;

FIG. 10 is a view showing an example in which the size of a filter before dilation is 3×3 and the dilation rate of dilated convolution is D=2:

FIG. 11 is a block diagram showing detailed configuration examples of a holding unit 402, a holding unit 404, and an arithmetic unit 406; and

FIG. 12 is a view showing a configuration example of the arithmetic unit 406.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

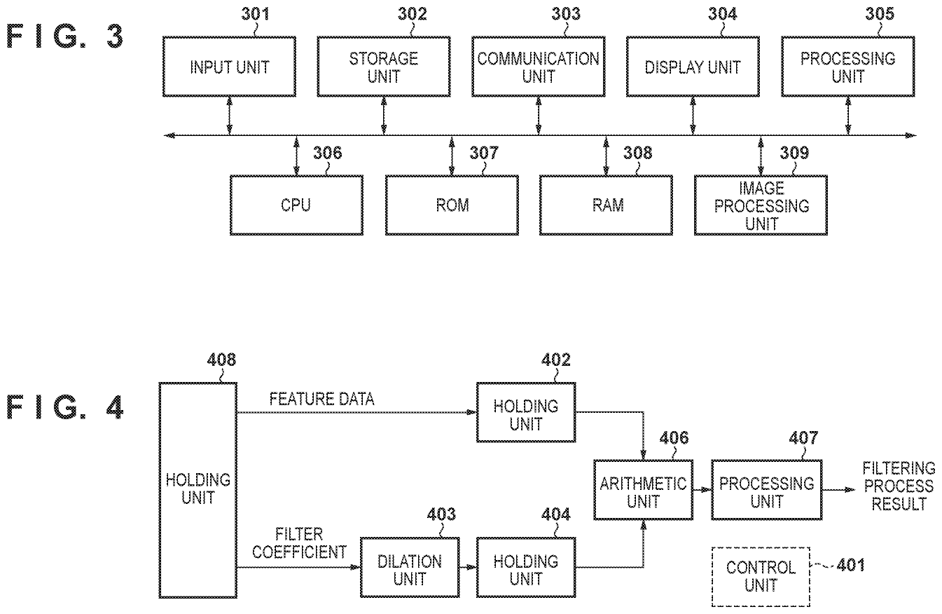

First, a hardware configuration example of a data processing apparatus that functions as a filtering apparatus for performing a filtering process on a plurality of data will be explained with reference to a block diagram shown in FIG. 3. A computer apparatus such as a PC (Personal Computer), a smartphone, or a tablet terminal apparatus can be applied to this data processing apparatus.

An input unit 301 is a user interface such as a keyboard, a mouse, or a touch panel. The user can input various instructions to a CPU 306 by operating the input unit 301.

A storage unit 302 is a memory device for storing various computer programs and data. Examples of the storage unit 302 are a hard disk, a flexible disk, a CD-ROM, a CD-R, a DVD, a memory card, a CF card, a smart medium, an SD card, a memory stick, a xD picture card, and a USB memory. The computer programs stored in the storage unit 302 include a computer program for causing the CPU 306 or a processing unit 305 to execute or control each processing (to be described later) to be performed by the data processing apparatus.

A communication unit 303 performs data communication with an external apparatus. For example, the communication unit 303 can receive, from an external apparatus, various kinds of information to be described later by assuming that they are stored in the storage unit 302, and store the received information in the storage unit 302.

A display unit 304 is a display device having a liquid crystal screen or a touch panel screen, and can display the results of processing performed by the CPU 306 and the processing unit 305 as images and characters. Note that the display unit 304 need not be an internal unit of the data processing apparatus and may also be an external device of the data processing apparatus. In this case, the display unit 304 is connected to the data processing apparatus so that the display unit 304 can communicate with the data processing apparatus by wired or wireless communication. It is also possible to form a touch panel screen by integrating the input unit 301 and the display unit 304.

The processing unit 305 performs a filtering process on data stored in a RAM 308 by performing a product-sum operation on the data by using a filter coefficient, under the control of the CPU 306. Then, the processing unit 305 stores the filtered data (the filtering process result) in a memory device such as the RAM 308 or the storage unit 302.

The CPU 306 executes various processes by using computer programs and data stored in the RAM 308 or a ROM 307. The CPU 306 thus controls the operation of the w % bole data processing apparatus, and executes or controls each processing (to be described later) to be performed by the data processing apparatus. Note that FIG. 3 shows one CPU 306, but the number of CPUs 306 can be 2 or more.

The ROM 307 stores information requiring no rewriting, such as a boot program and setting data of the data processing apparatus. The RAM 308 has an area for storing a computer program and data loaded from the ROM 307 or the storage unit 302, data received from an external apparatus by the communication unit 303, and the filtering process result output from the processing unit 305. In addition, the RAM 308 has a work area to be used by the CPU 306 or the processing unit 305 when executing various processes. Thus, the RAM 308 can appropriately provide the various areas. Note that a partial area in the RAM 308 can also be used as the storage unit 302.

When the data processing apparatus receives a computer program from an external apparatus via the communication unit 303, the data processing apparatus executes the computer program after storing the program once in the storage unit 302 and then loading the program into the RAM 308, or executes the program by directly loading it into the RAM 308 from the communication unit 303.

An image processing unit 309 reads out an image stored in the storage unit 302 and performs image processing such as range adjustment on the pixel value of each pixel of the image, and outputs the processed image (the image processing result) to the storage unit 302 or the RAM 308, under the control of the CPU 306.

Note that the obtaining sources and output destinations of various kinds of data explained in this embodiment are examples, and do not intend to limit them to the data obtaining sources and output destinations to be explained in this embodiment. Note also that FIG. 3 shows an arrangement in which all of the input unit 301, the storage unit 302, and the display unit 304 are included in one apparatus, but these functional units may also be connected by a communication path of a well-known communication system, and form an arrangement like this as a whole. That is, this arrangement shown in FIG. 3 is an example of a configuration to be applicable to an apparatus capable of performing a filtering process to be explained below, and can be changed and modified in various forms.

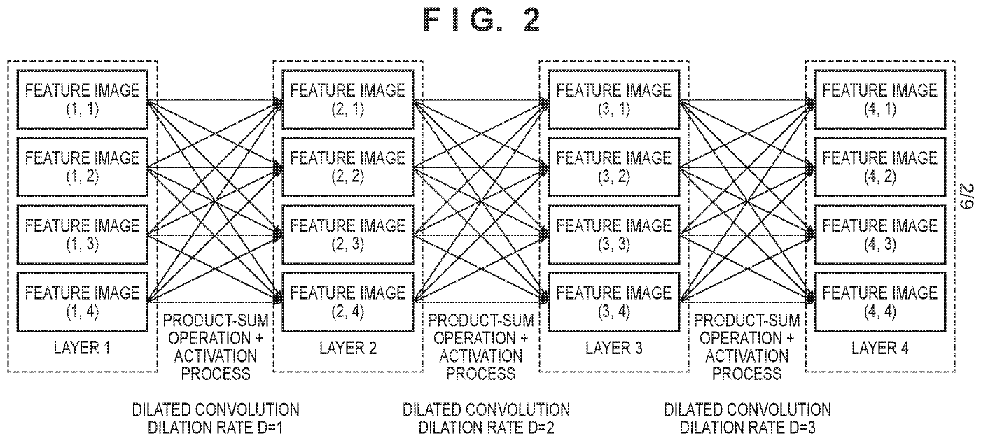

A configuration example of the hierarchical neural network (CNN) to be used in the filtering process by the processing unit 305 will be explained below with reference to FIG. 2. This hierarchical neural network shown in FIG. 2 has four layers, that is, layer 1, layer 2, layer 3, and layer 4, each layer has four feature images, and each feature image contains a plurality of feature data. In FIG. 2, feature images in layer L (L=1, 2, 3, 4) is represented by “feature image (L, i)” (i=1, 2, 3, 4) in which i is the index of the feature image. A feature image (output feature image) in a current layer is generated by performing convolution as a product-sum operation (filtering process) between feature data of a feature image (input feature image) in a preceding layer and a filter coefficient (weighting factor). Equation (3) below indicates a product-sum operation in which a filter coefficient (weighting factor) C to be used in the product-sum operation (equation (2)) in the filtering process is replaced with a filter coefficient C′ in an extended (dilated) filter indicated by equation (4) to be described later:

O_{i,j}(n)=Σₘ₌₁^{M}Σₓ₌₀^{D×(X-1)}Σ_{y=0}^{D×(Y-1)}(l_{i+x,j+y}(m)×C′_{x,y}(m,n)) (1)

In equation (3), variables common to equations (1) and (2) are as described earlier, so an explanation thereof will be omitted. Equation (4) below indicates a filter coefficient C′_{x,y}(m, n):

$${C}_{x , y}^{′} ( m , n ) = \{ \begin{matrix}{C}_{\frac{x}{D} , \frac{y}{D}} ( m , n ) , & if ⌊ \frac{x}{D} ⌋ = \frac{x}{D} , ⌊ \frac{y}{D} ⌋ = \frac{y}{D} \\ 0 , & otherwise\end{matrix} \qquad ( 4 )$$

When the values of x and y are multiples of D, the value of the filter coefficient C′_{x,y}(m, n) is the same as that of a filter coefficient C_{x/D,y/D}(m, n), and is a significant value (effective coefficient). On the other hand, if the values of x and y are not multiples of D, the value of the filter coefficient C′_{x,y}(m, n) is 0, and this means that the calculation will be omitted. In this case,

└x┘

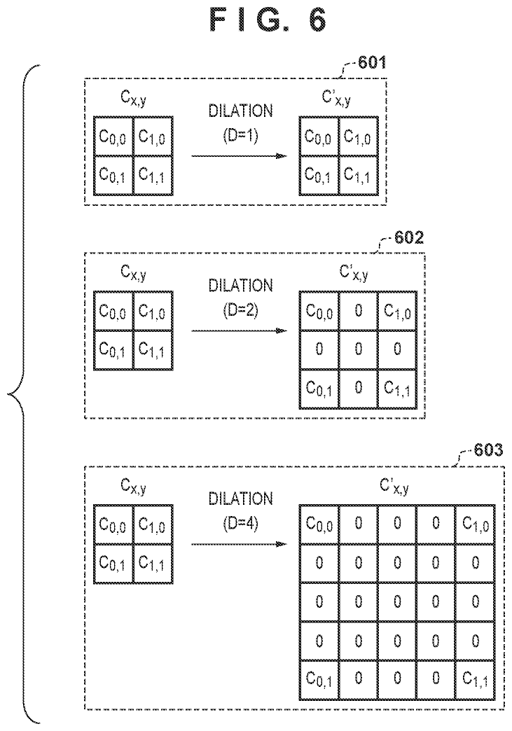

is a floor function, and outputs a maximum integer equal to or smaller than X FIG. 2 also shows the value of D (the dilation rate of dilated convolution) with respect to each layer. The size of a filter before dilation is 2×2, and the filter has four filter coefficients. FIG. 6 shows examples of filters before and after dilation. The dilation rate of the dilated convolution changes in accordance with each layer of the network.

The dilation rate of the dilated convolution in layer 1 is 1. As indicated in a frame 601, therefore, the filter is not dilated (extended) before and after dilation, so the filtering process (convolution) remains unchanged before and after dilation.

The dilation rate of the dilated convolution in layer 2 is 2. As indicated in a frame 602, therefore, the size of the filter after dilation (extension) is 3×3, and (multiple−1)=one 0 is inserted between filter coefficients adjacent to each other in the vertical and horizontal directions in the filter before dilation.

The dilation rate of the dilated convolution in layer 3 is 4. As indicated in a frame 603, therefore, the size of the filter after dilation (extension) is 5×5, and (multiple−1)=three 0s are inserted between filter coefficients adjacent to each other in the vertical and horizontal directions in the filter before dilation.

Next, the generation of a feature image in each layer will be explained. A plurality of feature images in layer 2 are generated by performing a product-sum operation using a plurality of feature images in layer 1 and filter coefficients based on equation (3). Then, a plurality of feature images in layer 3 are generated by performing a product-sum operation using the plurality of feature images in layer 2 and filter coefficients based on equation (3). Subsequently, a plurality of feature images in layer 4 are generated by performing a product-sum operation using the plurality of feature images in layer 3 and filter coefficients based on equation (3).

FIG. 8 shows an example of convolution in the hierarchical neural network. As shown in FIG. 8, feature data are extracted from the same positions (indicated by solid rectangles) in four feature images 801 in layer 1, and the result of a product-sum operation between the extracted feature data and filter coefficients is obtained as feature data in the same position (indicated by a solid rectangle) as the above position in a feature image 802 of the next layer (layer 2).

A configuration example of the processing unit 305 described above will be explained below with reference to a block diagram shown in FIG. 4. A control unit 401 controls the operation of the whole processing unit 305. A holding unit 408 holds feature data of a feature image, a filter coefficient corresponding to each filter, and structure information (for example, the calculation amount of a product-sum operation in each layer, the size of a feature image, and the number of feature images) as information on the structure of a hierarchical neural network

A holding unit 402 is a memory for holding each feature data in a feature image read out from the holding unit 408 under the control of the control unit 401. A dilation unit 403 stores a filter transferred from the holding unit 408 into a holding unit 404 under the control of the control unit 401. Then, the dilation unit 403 generates a dilated filter (extended filter) by dilating (extending) the stored filter in accordance with “a dilation rate corresponding to the current layer”, and stores the generated dilated filter in the holding unit 404.

An arithmetic unit 406 performs an arithmetic operation (filtering process) complying with abovementioned equation (3) by using the feature images stored in the holding unit 402 and the dilated filter stored in the holding unit 404.

A processing unit 407 performs an activation/pooling process on the result of the arithmetic operation performed by the arithmetic unit 406, and outputs the result of this activation/pooling process as a feature image in the current layer.

The feature data are held in the holding unit 402 as described above, and moved and output in order. When holding the feature data in a register in the holding unit 402, if a product-sum operation is performed in accordance with equation (2), it is difficult to refer to the feature data while skipping them. In this embodiment, therefore, a product-sum operation of equation (3) is performed by using a dilated filter obtained by dilating a filter.

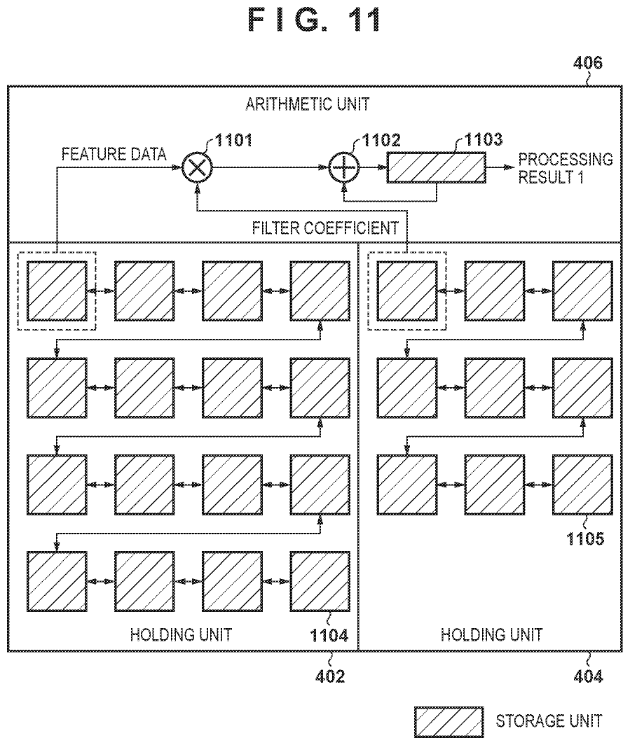

Detailed configuration examples of the holding unit 402, the holding unit 404, and the arithmetic unit 406 will be explained with reference to a block diagram shown in FIG. 11. The holding unit 402 has a plurality of storage units 1104 in order to hold each feature data of a feature image. The holding unit 404 has a plurality of storage units 1105 in order to hold each filter coefficient of a filter. Each storage unit 1104 can transfer feature data to an adjacent storage unit 1104. In the equation (equation (2)) of the conventional dilated convolution, feature data are referred to as they are skipped, so each storage unit 1104 must transfer the feature data to a nonadjacent storage unit, and this complicates the control and wiring. By contrast, this embodiment makes it unnecessary to transfer feature data by skipping them, because the dilated convolution is performed in accordance with equation (3), thereby making the control and wiring simpler than those of the conventional system.

The arithmetic unit 406 sets addresses (the storage unit 1104 and the storage unit 1105) for reading out data from the holding unit 402 and the holding unit 404, respectively. Then, a multiplier 1101 of the arithmetic unit 406 performs the multiplication of abovementioned equation (3) by using feature data read out from the address set in the holding unit 402, and a filter coefficient read out from the address set in the holding unit 404. An adder 1102 in the arithmetic unit 406 performs the addition of equation (3) by using the multiplication result from the multiplier 1101, cumulatively adds the result of the addition to the result of addition stored in a storage unit 1103, and stores the sum in the storage unit 1103.

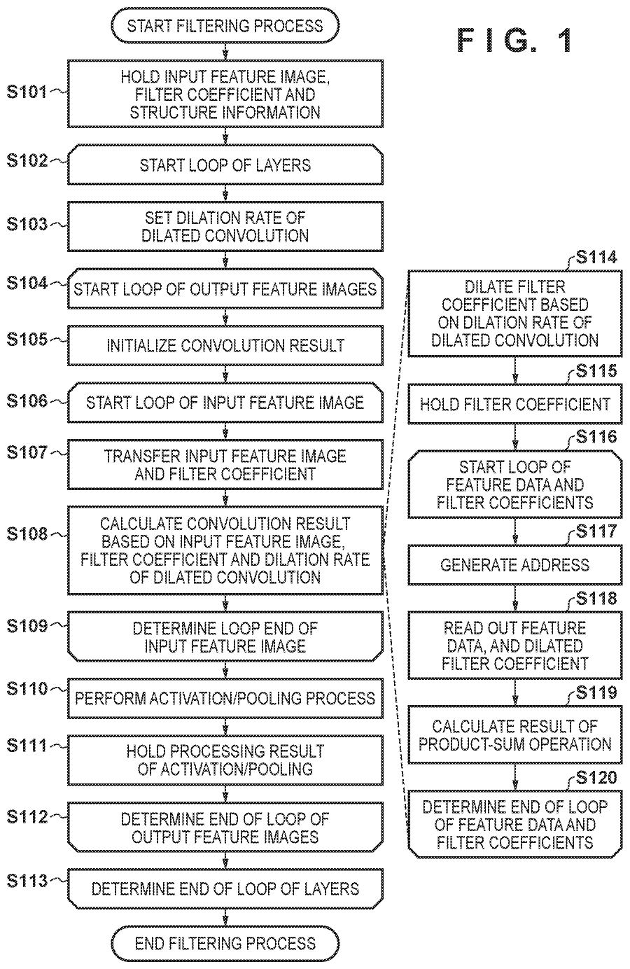

Next, the filtering process of the data processing apparatus according to this embodiment will be explained with reference to a flowchart shown in FIG. 1. In step S101, the control unit 401 reads out “feature data of a plurality of image features (input image features)”. “a filter coefficient of each filter”, and “structure information” from the storage unit 302, and stores them in the holding unit 408.

Processes in steps S102 to S113 are performed on each layer in the hierarchical neural network. In the example shown in FIG. 2, the processes in steps S102 to S113 are performed on each layer in the order of layers 1, 2, 3, and 4.

In step S103, the control unit 401 sets the dilation rate D of the dilated convolution in accordance with the structure information stored in the holding unit 408. In this embodiment, the dilation rate D of the same layer remains the same. However, it is also possible to set different dilation rates D for different feature images even in the same layer, and dilate a filter to be applied to a feature image of interest in accordance with the dilation rate D set for the feature image of interest. It is further possible to divide feature images into a plurality of groups, set the dilation rate D for each group, and dilate a filter to be applied to a feature image of interest in accordance with the dilation rate D set for a group to which the feature image of interest belongs.

Processes in steps S104 to S112 are performed on each feature image (output feature image) in the current layer. In the example shown in FIG. 2, the processes in steps S104 to S112 are performed on each of a feature image (L, 1), a feature image (L, 2), a feature image (L, 3), and a feature image (L, 4) in the current layer (a layer of index=L).

In step S105, the control unit 401 initializes the convolution result stored in the storage unit 1103 of the arithmetic unit 406 to 0. Processes in steps S106 to S109 are performed on each feature image (input feature image) in a preceding layer.

In step S107, the control unit 401 reads out each feature data of the input feature image from the holding unit 408, and transfers the feature data to the holding unit 402. Also, the control unit 401 reads out each filter coefficient of a filter from the holding unit 408, and transfers the filter coefficient to the dilation unit 403.

In step S108, the dilation unit 403 stores the transferred filter in the holding unit 404, generates a dilated filter by dilating the stored filter in accordance with the dilation rate set in step S103, and stores the dilated filter in the holding unit 404. Then, the arithmetic unit 406 performs convolution (a filtering process) complying with abovementioned equation (3) by using the input feature image transferred to the holding unit 402, and the dilated filter stored in the holding unit 404. In step S108, processes in steps S114 to S120 are performed. Details of step S108 will be described later.

When the process has advanced to step S110, the convolution on all input feature images in the preceding layer is complete. In step S110, the processing unit 407 performs an activation process in accordance with equation (5) below, on the result of convolution of all the input feature images in the preceding layer:

$$f ( x ) = \{ \begin{matrix}0 , x < 0 \\ x , x \geq 0\end{matrix} \qquad ( 5 )$$

In equation (5), f( ) is an activation function, and x is the result of convolution. In this example, the activation function is implemented by using a ReLU (Rectified Linear Unit). However, the activation function is not limited to the ReLU, and can also be implemented by using another nonlinear function or a quantization function. Then, in accordance with information of the layer, the processing unit 407 performs a pooling process based on the activation process result, and adjusts the size of an output feature image as needed.

In step S111, the processing unit 407 stores the output feature image generated in the process in step S110 into the holding unit 402 so as to use this output feature image as an input feature image for obtaining an output feature image in the next layer. By performing the process as described above, each feature image (an output feature image) in the next layer can be generated.

In the processing complying with the flowchart shown in FIG. 1, a filter is transferred to the holding unit 404 and then dilated. This achieves the effect of shortening the transfer time compared to a case in which a dilated filter is transferred.

Details of the convolutional arithmetic operation (steps S114 to S120) using feature data of a feature image and a filter coefficient of a dilated filter in abovementioned step S108 will be explained below.

In step S114, the dilation unit 403 stores a filter transferred from the holding unit 408 into the holding unit 404, and generates a dilated filter by dilating the stored filter in accordance with the dilation rate D set in step S103. More specifically, the dilation unit 403 calculates a filter coefficient C′_{x,y}(m, n) of the dilated filter based on a filter coefficient C_{x,y}(m, n) of a nondilated filter.

In step S115, the dilation unit 403 stores the dilated filter generated in step S114 into the holding unit 404. Processes in steps S116 to S120 are performed on each set of feature data and a filter coefficient.

In step S117, the arithmetic unit 406 sets an address for reading out data from the holding units 402 and 404, that is, an address corresponding to x and y in equation (4), and determines the order of reading out feature data and filter coefficients.

In step S118, the multiplier 1101 of the arithmetic unit 406 reads out feature data from the address set in the holding unit 402, and reads out a filter coefficient from the address set in the holding unit 404.

A plurality of feature data are held in the plurality of storage units 1104. The holding unit 402 outputs feature data by transferring feature data held in the storage unit 1104 to the adjacent storage unit 1104.

In step S119, the multiplier 1101 of the arithmetic unit 406 performs the multiplication of equation (3) by using the feature data read out in step S118 and the filter coefficient read out in step S118. The adder 1102 of the arithmetic unit 406 performs the addition of equation (3) by using the multiplication result from the multiplier 1101, cumulatively adds the result of the addition to the result of addition stored in the storage unit 1103, and stores the result of the cumulative addition in the same storage unit 1103. The addition result stored in the storage unit 1103 when the process has advanced to step S109 is the result of convolution corresponding to one input feature image, so this convolution result is a target to be processed in step S110.

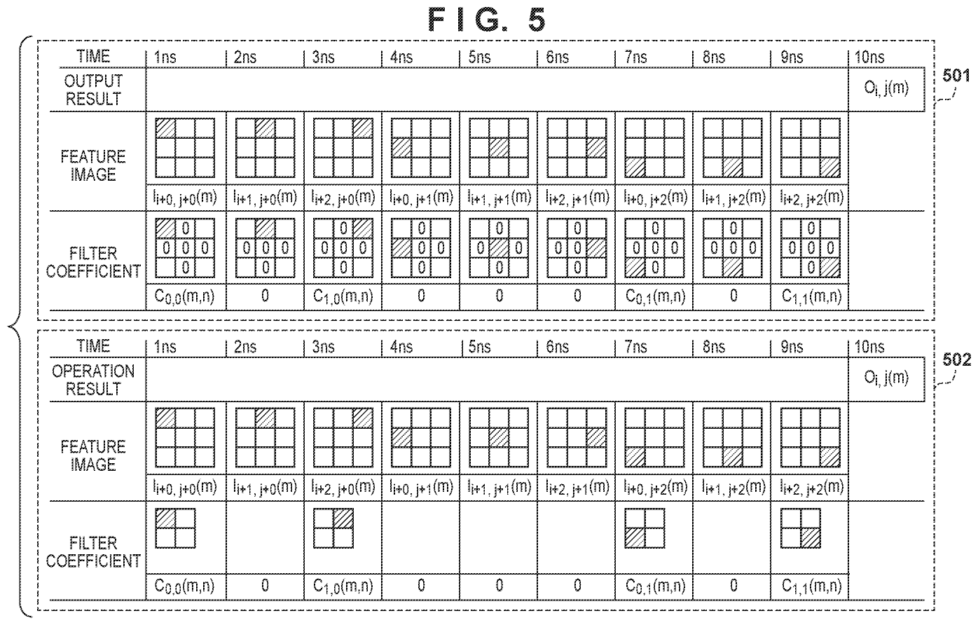

As described above, the data processing apparatus according to this embodiment can efficiently process a dilated filter while referring to feature data one by one. A frame 501 in FIG. 5 shows examples of an effective coefficient (nonzero filter coefficient) of a dilated filter and the processing time. A frame 602 in FIG. 6 shows examples of filters before and after dilation when dilation rate D=2.

The time axis is expressed by 1 ns to 10 ns. At 1 ns, the product of upper left feature data I_{i,j}(m) in a feature image and a filter coefficient C_{0,0}(m, n) is calculated and used as the initial value of the cumulative value of convolution. At 2 ns, the product of feature data I′_{i+1,j}(m) of the feature image and a filter coefficient of 0 is calculated and added to the cumulative value. At 3 ns, the product of upper right feature data I′_{i+2,j}(m) of the feature image and a filter coefficient C_{1,0}(m, n) is calculated and added to the cumulative value. At 4 ns to 6 ns, the products of feature data of the feature image and a filter coefficient of 0 are calculated and added to the cumulative value. At 7 ns, lower left feature data I′_{i,j+2}(m) of the feature image and a filter coefficient C_{0,1}(m, n) is calculated and added to the cumulative value. At 8 ns, feature data I′_{i+1,j+2}(m) of the feature image and a filter coefficient of 0 is calculated and added to the cumulative value. At 9 ns, the product of lower right feature data I′_{i+2,j+2}(m) of the feature image and a filter coefficient C′_{1,1}(m, n) is calculated and added to the cumulative value. At 10 ns, the cumulative value is output as the convolution result.

Note that when the filter coefficient is 0, the product of feature data and a filter coefficient of 0 is calculated and added to the cumulative value in the above explanation. To reduce the calculation cost, however, it is also possible to omit the process of calculating the product of feature data and a filter coefficient of 0 and adding the product to the cumulative value.

The CPU 306 obtains the image processing result based on the output result from the final layer (layer 4 in the example shown in FIG. 2) in the hierarchical neural network as described above. Assume that a captured image (an image of each frame in a moving image or a still image) is input to the input layer (layer 1 in the example shown in FIG. 2) of the hierarchical neural network, and the output result is obtained from the final layer by performing the abovementioned arithmetic operation of the hierarchical neural network. In this case, the CPU 306 performs image processing or image recognition on the captured image based on the output result. The result of the image processing or the image recognition performed by the CPU 306 is stored in the RAM 308, the storage unit 302, or the like.

As described above, this embodiment can perform dilated convolution while processing feature data one by one. Also, the filter transfer amount does not increase because not a dilated filter but a nondilated filter is transferred. The effect is particularly large in a CNN that hierarchically performs a large number of convolutions.

### Second Embodiment

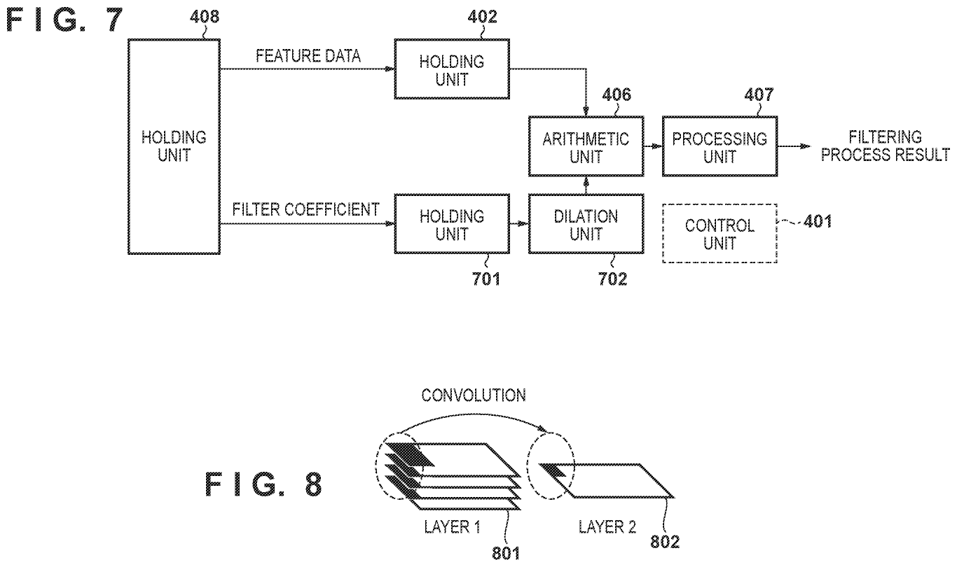

In the second embodiment, the difference from the first embodiment will be explained, and the rest is the same as the first embodiment unless otherwise specified. A block diagram of FIG. 7 shows a configuration example of a processing unit 305 according to this embodiment. The same reference numerals as shown in FIG. 4 denote the same functional units in FIG. 7, and an explanation thereof will suitably be omitted.

A holding unit 701 is a memory for holding a filter read out from a holding unit 408 under the control of a control unit 401. From the filter stored in the holding unit 701, a dilation unit 702 generates a dilated filter that is dilated in accordance with a dilation rate corresponding to the current layer, and outputs the dilated filter. An arithmetic unit 406 performs an arithmetic operation (filtering process) complying with abovementioned equation (3) by using feature data stored in a holding unit 402 and a filter coefficient output from the dilation unit 702.

The filtering process to be performed by a data processing apparatus according to this embodiment differs from that of the first embodiment in the following point. In step S107, the control unit 401 reads out each feature data of an input feature image from the holding unit 408, and transfers the data to the holding unit 402. Also, the control unit 401 reads out a filter from the holding unit 408, and transfers the filter to the holding unit 701.

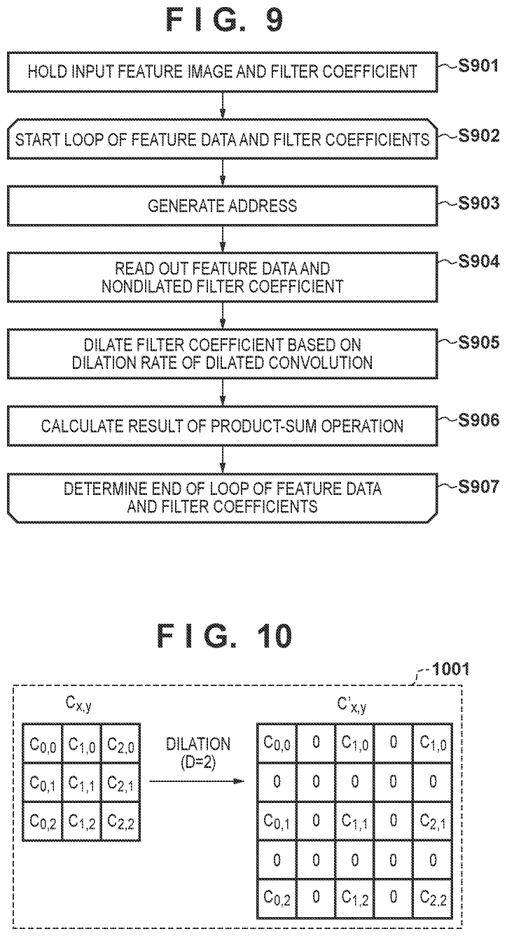

In step S108 of this embodiment, processes in steps S901 to S907 shown in FIG. 9 are performed. In step S901, the control unit 401 stores the feature data transferred to the holding unit 402 into the holding unit 402. In addition, the control unit 401 stores the filter transferred to the holding unit 701 into the holding unit 701. The processes in steps S902 to S907 are performed for each set of feature data and a filter coefficient.

In step S903, the arithmetic unit 406 sets an address for reading out data from the holding units 402 and 701, that is, an address corresponding to x and y of equation (4), and determines the order of reading out feature data and filter coefficients. In this step, the arithmetic unit 406 notifies the dilation unit 702 of the address corresponding to x and y, only when both of x and y are multiples of a dilation rate D.

In step S904, a multiplier 1101 of the arithmetic unit 406 reads out feature data from the address set in the holding unit 402. Also, if the address is notified from the arithmetic unit 406, the dilation unit 702 reads out a filter coefficient from the notified address in the holding unit 701.

In step S905, the dilation unit 702 outputs the filter coefficient read out from the holding unit 701 if the address is notified from the arithmetic unit 406, or outputs “0” as a filter coefficient if not. A filter formed by arranging the filter coefficients output from the dilation unit 702 in order is “a dilated filter having a size obtained by multiplying a nondilated filter by D”. That is, in this embodiment, a nondilated filter is held in the holding unit 701, and the dilation unit 702 generates a dilated filter from the nondilated filter, and outputs a filter coefficient of the generated dilated filter.

In step S906, the multiplier 1101 of the arithmetic unit 406 performs the multiplication of equation (3) by using the feature data read out in step S904, and the filter coefficient output from the dilation unit 702 in step S905. An adder 1102 of the arithmetic unit 406 performs the addition of equation (3) by using the multiplication result from the multiplier 1101, cumulatively adds the result of the addition to the result of the addition stored in a storage unit 1103, and stores the result of the cumulative addition in the storage unit 1103.

As described above, since the filter coefficient of a nondilated filter is transferred from the holding unit 408 to the holding unit 701, the transfer time is shorter than that when the filter coefficient of a dilated filter is transferred. Also, unlike the first embodiment, the holding unit 701 of this embodiment holds not the filter coefficient of a dilated filter but the filter coefficient of a nondilated filter, so the memory size is reduced compared to that of the first embodiment.

The data processing apparatus according to this embodiment can efficiently process a nondilated filter by referring to feature data one by one. A frame 502 in FIG. 5 shows examples of the filter coefficient and the processing time equivalent to step S905. The dilation rate of dilated convolution is D=2, and a frame 602 in FIG. 6 shows examples of filter coefficients before and after dilation. The processing is performed divisionally by 10 steps (10 ns) in the same manner as in the first embodiment.

The processing order is the same as that of the first embodiment. Since, however, filter coefficients before dilation are held, both x and y are not multiples of the dilation rate D at 2 ns, 4 to 6 ns, and 8 ns, so the filter coefficient is 0. In this embodiment, however, dilated convolution can be performed because filter coefficient of 0 need not be held in a memory.

### Third Embodiment

In the first embodiment, the form in which the processing unit 407 performs the activation process has been explained, but another functional unit can also execute the activation process. For example, the CPU 306 can execute the activation process. This similarly applies to other processes, so the subject of each process is not limited to that explained above.

Also, in FIGS. 4, 7, 11, and 12, each functional unit except the functional units that function as memories (for example, the holding units and the storage units) can be implemented by hardware, and can also be implemented by software (a computer program) either partially or entirely. In the latter case, this computer program is stored in the storage unit 302, and the CPU 306 or the processing unit 305 (the control unit 401) can implement the function of the corresponding functional unit by executing the computer program.

In the first embodiment, the form in which the activation/pooling process is executed in accordance with the network structure of a hierarchical neural network has been explained. However, one or both of the activation and the pooling are omitted case by case.

In the first embodiment, the arithmetic unit 406 has one set of the multiplier 1101, the adder 1102, and the storage unit 1103. However, the arithmetic unit 406 may also have a plurality of sets each including the multiplier 1101, the adder 1102, and the storage unit 1103. In this case, the processing speed can be increased by operating these sets in parallel.

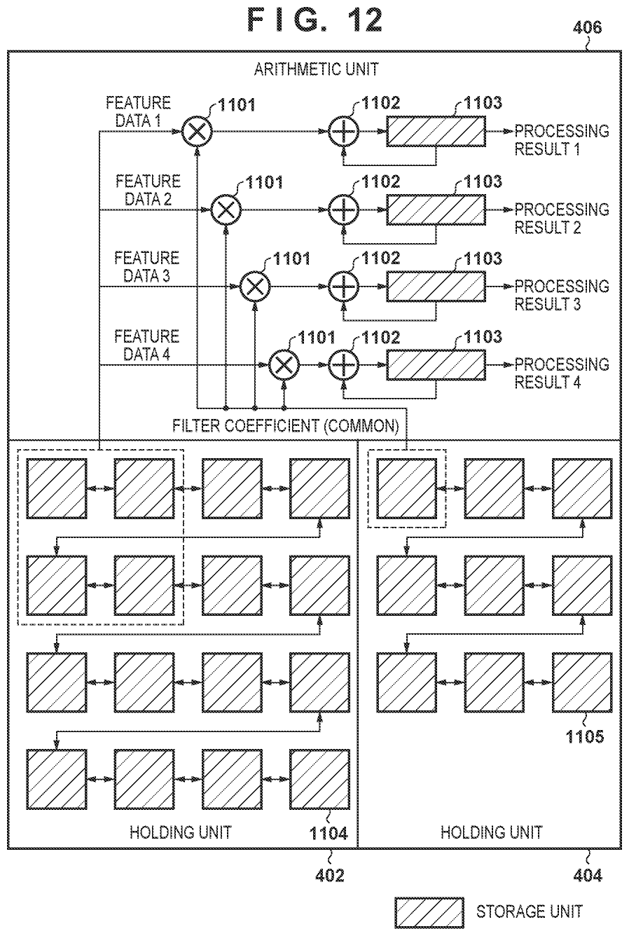

FIG. 12 shows a configuration example of the arithmetic unit 406 having four sets each including the multiplier 1101, the adder 1102, and the storage unit 1103. In this configuration, the processing efficiency of dilated convolution can be increased by processing a common filter coefficient and a plurality of feature data in parallel.

In the first embodiment, an example in which the size (the height and the width) of a nondilated filter is 2×2 has been explained, but the filter size is not limited to this size and can also be any arbitrary size. FIG. 10 shows an example in which the size (the height and the width) of a nondilated filter is 3×3 and the dilation rate of dilated convolution is D=2. The size of a dilated filter is 5×5.

In the first embodiment, an example in which the dilation rate D of dilated convolution is 1, 2, or 4 and the filter size is 2×2 has been explained, but they are not limited to these values and may also be any dilated convolution dilation rate and any size.

In the second embodiment, the form in which “0” is outputted as a filter coefficient upon dilation of a filter coefficient has been explained. However, non-adjacent feature data stored in the holding unit 402 may also be able to be read out consecutively. In this case, non-dilated filter coefficients can be read out from the holding unit 701 consecutively and “0” does not need to be outputted.

The numerical values, the arithmetic methods, the process execution timings, and the like used in each of the abovementioned embodiments are merely examples, and do not intend to limit each embodiment to these examples.

Some or all of the above-described embodiments may be combined and used. Some or all of the above-described embodiments may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-042183, filed Mar. 11, 2020, which is hereby incorporated by reference herein in its entirety.

What is claimed is:

1. A data processing apparatus comprising:
a holding unit configured to hold filter coefficients of a transferred filter;
a generating unit configured to generate an extended filter by extending a size of the transferred filter while sequentially reading out the filter coefficients held in the holding unit; and
an arithmetic unit configured to perform convolution by using filter coefficients of the extended filter.

2. The apparatus according to claim 1, wherein the generating unit stores filter coefficients of the generated extended filter in a memory.

3. The apparatus according to claim 1, wherein the generating unit stores the filter coefficients held in the holding unit into a memory, and generates the extended filter by extending the size of the filter by using the filter coefficients stored in the memory.

4. The apparatus according to claim 1, wherein the generating unit generates the extended filter by adding a coefficient of 0 to the held filter coefficients.

5. The apparatus according to claim 4, wherein the generating unit generates the extended filter by inserting (extension dilation rate−1) 0s as coefficients between filter coefficients adjacent to each other in vertical and horizontal directions in the held filter coefficients.

6. The apparatus according to claim 1, wherein the generating unit generates the extended filter for each layer.

7. The apparatus according to claim 6, wherein the arithmetic unit performs, for each layer, convolution corresponding to the layer by using the filter coefficients of the extended filter generated for the layer by the generating unit.

8. The apparatus according to claim 6, wherein the generating unit generates the extended filter by extending a size of the transferred filter in accordance with a dilation rate corresponding to the layer.

9. The apparatus according to claim 6, wherein the generating unit generates the extended filter by extending a filter to be applied to data to be convoluted, in accordance with a dilation rate set for the data.

10. The apparatus according to claim 6, wherein the generating unit generates the extended filter by extending a filter to be applied to data to be convoluted, in accordance with a dilation rate set for a group to which the data belongs.

11. The apparatus according to claim 9, wherein the layer is each layer of a hierarchical neural network, the data is feature data contained in a feature image of the layer, and the filter coefficients are weighting factors corresponding to the layer.

12. The apparatus according to claim 1, wherein the arithmetic unit performs an activation process and/or a pooling process on a result of the convolution.

13. A data processing method to be performed by a data processing apparatus, comprising:
holding filter coefficients of a transferred filter;
generating an extended filter by extending a size of the transferred filter while sequentially reading out the held filter coefficients; and
performing convolution by using filter coefficients of the extended filter.

14. A non-transitory computer-readable storage medium storing a computer program for causing a computer to function as:
a generating unit configured to generate an extended filter by extending a size of a transferred filter while sequentially reading out filter coefficients of the transferred filter; and
an arithmetic unit configured to perform convolution by using filter coefficients of the extended filter.
